(19) United States
(12) Patent Application Publication
(10) Pub. No.: US 2025/0190195 A1
(43) Pub. Date: Jun. 12, 2025

(54) METHOD, SYSTEM, AND DEVELOPMENT MACHINE FOR EVALUATING EMBEDDED PROJECT USING WEB BROWSER

(71) Applicant: ESPRESSIF SYSTEMS (SHANGHAI) CO., LTD., Shanghai (CN)

(72) Inventors: Amey INAMDAR, Pune (IN); Kedar SOVANI, Pune (IN); Adwait PATANKAR, PUNE (IN)

(21) Appl. No.: 18/844,938

(22) PCT Filed: Dec. 22, 2022
(86) PCT No.: PCT/CN2022/140889

§ 371 Date: Sep. 6, 2024

(30) Foreign Application Priority Data
Mar. 7, 2022 (IN) 202211012113

(51) Int. Cl. G06F 8/61; G06F 11/3698

(52) U.S. Cl. CPC G06F 8/63; G06F 11/3698

(57) ABSTRACT

A method for evaluating an embedded project, a development machine and a system for evaluating an embedded project are disclosed. The method comprising the steps of: receiving a trigger command from a user, obtaining the manifest provided by a developer of the embedded project, dynamically generating an interactive web interface and displaying the interactive web interface to the user; obtaining the project file to be written by using the web application, writing the image file in the project file into the firmware storage area of the embedded board connected to the development machine, so as to run the embedded project on the embedded board for evaluation. The present disclosure uses the network to realize the evaluation of the embedded project, without a series of complicated operations such as copying, installation, and compilation on the development machine.

### CROSS-REFERENCE TO RELATED APPLICATIONS

This application is the U.S. National Phase application under 35 U.S.C. § 371 of International Patent Application No. PCT/CN2022/140889 filed on Dec. 22, 2022, which claims priority to Indian Patent Application IN202211012113 filed on Mar. 7, 2021. The disclosures of the aforementioned applications are hereby incorporated by reference in their entireties.

### TECHNICAL FIELD

The present disclosure relates to the field of embedded technology, and in particular to a method for evaluating an embedded project, a development machine, and a system for evaluating an embedded project.

### BACKGROUND ART

In the prior art, methods for evaluating an embedded project provided in open-source repositories (such as github.com, gitlab.com) generally include the following steps:
copying or cloning the embedded project and dependencies onto the development machine;
installing necessary tools and libraries, such as base SDK (Software Development Kit), toolchain, additional packages;
compiling the embedded project;
connecting an embedded development board to the development machine and installing a USB (Universal Serial Bus) to serial driver;
using the compiled embedded project to program the embedded development board; and
running the embedded project on the embedded development board for evaluation.

In the existing evaluation methods, the process is relatively time-consuming due to the need to download the embedded project from the network and copy or clone it on the development machine. Moreover, the differences between the development machines may be prone to human errors in the process of installing the necessary tools and libraries. In addition, the process of compiling the project also takes a lot of time, and it is also prone to failure due to changes in dependencies.

It can be seen that the existing evaluation methods may be time consuming, and may be prone to more human errors.

It should be understood that the technical problems listed above are merely examples rather than limitations to the present disclosure, and the present disclosure is not limited to technical solutions that simultaneously solve all the above technical problems. The technical solution of the present disclosure may be implemented to solve one or more of the above or other technical problems.

### SUMMARY OF THE INVENTION

In order to solve the above and other problems, a method implemented by a development machine for evaluating an embedded project is provided in the present disclosure, and the method comprises the following steps:
receiving a trigger command from a user, the trigger command being used to obtain a manifest file provided by a developer of the embedded project;
based on the manifest file, dynamically generating an interactive web interface of a web application and displaying the interactive web interface to the user;
obtaining at least a project file to be written by using the web application, wherein the project file to be written is stored on a remote server and comprises at least a pre-built image file of the embedded project; and
writing the image file into a firmware storage area of the embedded board connected to the development machine, so as to run the embedded project on the embedded board for evaluation.

Optionally, the step of, based on the manifest file, dynamically generating an interactive web interface of a web application and displaying the interactive web interface to the user comprises:
obtaining a pre-built manifest file from the remote server; and
rendering a webpage based on the manifest file to obtain the interactive web interface, and displaying the interactive web interface to the user.

Optionally, the step of obtaining at least a project file to be written by using the web application comprises:
obtaining, from the manifest file, a path where the project file to be written is stored on the remote server; and
obtaining the project file to be written based on the path by means of the web application.

Optionally, the method further comprises:
displaying a pre-established link on the interactive web interface based on the data in the manifest file.

Optionally, the manifest file further comprises constraints information, which is used to specify which type of chip and/or embedded board the embedded project supports.

Optionally, after the step of displaying the interactive web interface to the user, the method further comprises:
receiving the type of chip and/or embedded board to be used as an input by the user through the interactive web interface; and
determining whether the type of chip and/or embedded board to be used is a type supported by the embedded project, and if so, executing an operation of writing the image file into the firmware storage area of the embedded board.

Optionally, the manifest file further comprises an offset, and based on the offset, the image file is written to a designated location of the firmware storage area.

Optionally, after the step of displaying the interactive web interface to the user, the method further comprises:
receiving input information by the user through the interactive web interface, and transmitting the input information to the embedded project running on the embedded board.

Optionally, after the step of displaying the interactive web interface to the user, the method further comprises:
providing a link in the interactive web interface to download a phone application required to evaluate the embedded project.

Optionally, the project file to be written is an embedded project file stored in an open-source repository or any file storage accessible over web.

Optionally, the trigger command is clicking on a pre-established link.

Optionally, the web application is a JavaScript application, which communicates with the embedded board through a web-serial interface.

A development machine is also provided in the present disclosure, which comprising a memory and a processor, the memory is configured to store instructions, and the instructions, when executed by the processor, implement the above-mentioned methods.

A system for evaluating an embedded project is also provided in the present disclosure, and the system comprising: an embedded board, a remote server and the above-mentioned development machine.

The method for evaluating an embedded project provided by this disclosure, on receipt of a trigger command from the user, the trigger command is used to obtain the manifest file provided by the developer of the embedded project; based on the manifest file, dynamically generates an interactive web interface of a web application and displays the interactive web interface to the user; obtains at least a project file to be written by using the web application, writes the image file into the firmware storage area of the embedded board connected to the development machine, so as to run the embedded project on the embedded board for evaluation. The present disclosure uses the network to realize the evaluation of the embedded project, without a series of complicated operations such as copying, installation, and compilation on the development machine. This disclosure can quickly program the embedded board in a simple way, and realize the project evaluation in a few steps. It can avoid time-consuming problems and reduce the chance of human errors or setup errors. In addition, a development machine and a system for evaluating an embedded project with the above-mentioned technical effects are also provided in this disclosure.

### BRIEF DESCRIPTION OF THE DRAWINGS

Hereinafter, the present disclosure will be further explained based on the embodiments with reference to the drawings.

FIG. 1 schematically shows a flowchart of a specific implementation of the method for evaluating an embedded project provided by the present disclosure;

FIG. 2 schematically shows a flowchart of another specific implementation of the method for evaluating an embedded project provided by the present disclosure;

FIG. 3 schematically shows a structural block diagram of the development machine provided by this disclosure;

FIG. 4 schematically shows a structural block diagram of the system for evaluating an embedded project provided by this disclosure; and

FIG. 5 schematically shows a working flowchart of the system for evaluating an embedded project provided by the present disclosure.

### DETAILED DESCRIPTION OF THE PREFERRED EMBODIMENTS

The method and system of the present disclosure will be described in detail below with reference to the drawings and specific embodiments. It should be understood that the embodiments shown in the drawings and described below are merely illustrative, and are not intended to limit the application.

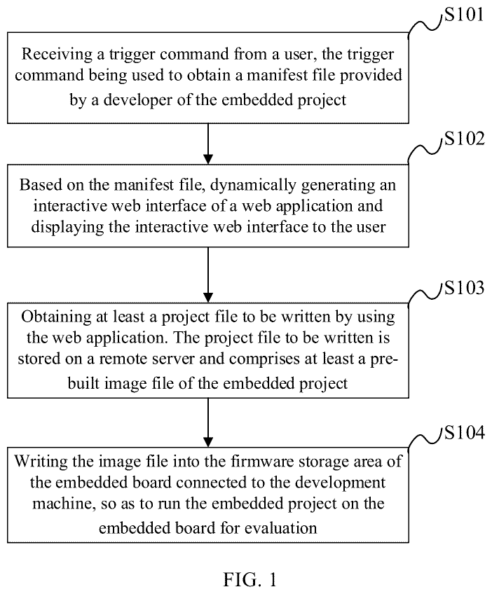

FIG. 1 shows a flowchart of a specific implementation of the method for evaluating an embedded project provided by the present disclosure. The method is implemented to a development machine and specifically comprises the following steps:
S101: receiving a trigger command from a user, the trigger command being used to obtain a manifest file provided by a developer of the embedded project.

In the embodiment, the trigger command may be clicking on a pre-established link. For example, a URL (Uniform Resource Locator) may be provided in the README file, and the subsequent operation of obtaining the manifest file provided by the developer of the embedded project is triggered by clicking the link by the user. Of course, the trigger command may also adopt other methods, which are not limited here.
S102: based on the manifest file, dynamically generating an interactive web interface of a web application and displaying the interactive web interface to the user.

The manifest file in the embodiment of the present disclosure may be created by the developer of the embedded project to facilitate the evaluation by other users. Rendering a webpage based on the data in the provided manifest file, and dynamically generating an interactive web interface of a web application. The interactive web interface serves as a channel for the user to interact with the web application, through which the user can input information or perform operations to the web application, and the web application may provide information to the user through the interactive web interface. After the interactive web interface is generated, the interactive web interface may be displayed to the user. It can be understood that the interactive web interface may comprise components that display data, and may also comprise components that interact with the user, such as a text box that receives input from the user, and a click box that receives selection from the user.

Further, the embodiment of the present disclosure may further comprise: displaying a pre-established link on the interactive web interface based on the data in the manifest file. The pre-established link may be, for example, a mobile phone app link or a URL used to trigger an evaluation.

As a specific implementation, in the embodiment of the present disclosure, the step of dynamically generating an interactive web interface and displaying the interactive web interface to the user comprises: obtaining a pre-built manifest file from the remote server; rendering a webpage based on the manifest file to obtain the interactive web interface, and displaying the interactive web interface to the user.
S103: obtaining at least a project file to be written by using the web application. The project file to be written is stored on a remote server and comprises at least a pre-built image file of the embedded project.

The project file to be written in the embodiment of the present disclosure may be a binary file, which at least comprises an image file. After the project file to be written is created by the developer of the embedded project, it may be stored on the remote server. The web application may download the project file to be written in the background.

It is understandable that in this embodiment the project file to be written is an embedded project file stored in an open-source repository or an embedded project file stored in any file storage accessible over web.

As a specific implementation, the manifest file may comprise the path where the project file to be written is stored on the remote server. In this embodiment, the step of obtaining the project file to be written by using the web application comprises: obtaining, from the manifest file, a path where the project file to be written is stored on the remote server; obtaining the project file to be written based on the path by means of the web application.
S104: writing the image file into the firmware storage area of the embedded board connected to the development machine, so as to run the embedded project on the embedded board for evaluation.

Specifically, the above-mentioned method of the embodiment of the present disclosure may be executed by a web application running on a development machine. The web application may be a JavaScript application, which communicates with the embedded board through a web-serial interface. The web application writes the image file to be written of the project file into the firmware storage area of the embedded board. Running the embedded project on the embedded board for evaluation.

The method for evaluating an embedded project provided by this disclosure, on receipt of a trigger command from the user, the trigger command is used to obtain the manifest file provided by the developer of the embedded project; based on the manifest file, dynamically generates an interactive web interface and displays the interactive web interface to the user; obtains at least a project file to be written by using the web application, writes the image file into the firmware storage area of the embedded board connected to the development machine, so as to run the embedded project on the embedded board for evaluation. The present disclosure uses the network to realize the evaluation of the embedded project, without a series of complicated operations such as copying, installation, and compilation on the development machine. This disclosure can quickly program the embedded board in a simple way, and realize the project evaluation in a few steps. It can avoid time-consuming problems and reduce the chance of human errors or setup errors.

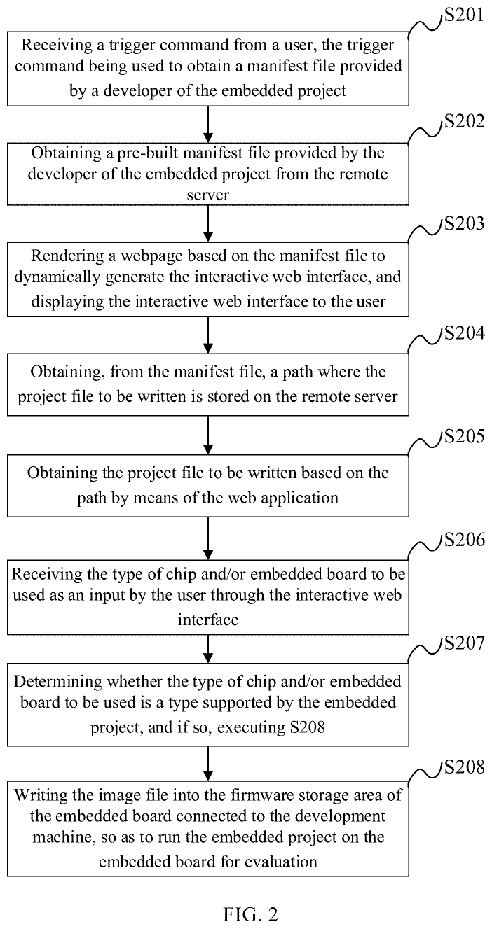

The flowchart of another specific implementation of the method for evaluating an embedded project provided by the present disclosure is shown in FIG. 2. With reference to FIG. 2, the method specifically comprises:
S201: receiving a trigger command from a user, the trigger command being used to obtain a manifest file provided by a developer of the embedded project.

As a specific implementation, the trigger command may be clicking on a pre-established link. For example, the URL may be provided in the README file, and the subsequent operation of obtaining the manifest file provided by the developer of the embedded project is triggered by clicking the link by the user.
S202: obtaining a pre-built manifest file provided by the developer of the embedded project from the remote server.

The manifest file in this embodiment may specifically comprise the following information: data required for rendering the interactive web interface, the path of the project file to be written, offset, constraints information, information input by the user through the interactive web interface, and other information. In this embodiment, if the project consists of multiple image files, the offset may be used to indicate that the image files are written at different offsets in the firmware storage area. Based on the offset, the image files may be written to a designated location of the firmware storage area. It can be understood that the firmware storage area may be a flash memory or other storage device. The constraints information is used to show the user the available choices, such as to specify which types of chips the embedded project supports, and/or which type of embedded board the embedded project supports. It shall be understood that different types of embedded boards in combination with different types of chips installed on the embedded boards may impose different requirements on the applicable firmware image files. Other information may also comprise the mobile phone app required to run the embedded project, etc.
S203: rendering a webpage based on the manifest file to dynamically generate the interactive web interface, and displaying the interactive web interface to the user.

According to the data required for rendering the interactive web interface of the manifest file, rendering the webpage to dynamically generate the interactive web interface. The information displayed on the interactive web interface may be displayed to the user, and the user may also perform interactive operations such as data input or selection through the interactive web interface, which is not limited here.
S204: obtaining, from the manifest file, a path where the project file to be written is stored on the remote server.
S205: obtaining the project file to be written based on the path by means of the web application.

The path of the project file to be written may be obtained from the manifest file. Based on the path, the web application may obtain the project file to be written from the remote server. The process may be executed in the background.
S206: receiving the type of chip and/or embedded board to be used as an input by the user through the interactive web interface.

In this embodiment, the interactive web interface may automatically list the types of chips and embedded boards supported by the embedded project based on the information in the manifest file. And the user may also input the type of chip and embedded board to be used through the interactive web interface.
S207: determining whether the type of chip and/or embedded board to be used is a type supported by the embedded project, and if so, executing S208.

If the type of chip and/or embedded board to be used is the type supported by the embedded project, the subsequent operation of writing the image file into the firmware storage area of the embedded board is performed. And if the type of chip and/or embedded board to be used is not the type supported by the embedded project, the subsequent operation of writing the image file into the firmware storage area of the embedded board is not performed.
S208: writing the image file into the firmware storage area of the embedded board connected to the development machine, so as to run the embedded project on the embedded board for evaluation.

During the writing process, if multiple image files are included in the project to be written, different image files may be written to the appropriate location of the firmware storage area based on the offset.

In addition, after displaying the interactive web interface to the user, the embodiments of this disclosure further comprise: receiving input information by the user through the interactive web interface, and transmitting the input information to the embedded project run on the embedded board. For example, the user may enter information such as Wi-Fi SSID (Service Set Identifier) and password through the text box or other tools on the interactive web interface, and this information may be used by the embedded project running on the embedded board. For example, the Wi-Fi SSID or password entered by the user may be used by the embedded project to establish a Wi-Fi connection.

After displaying the interactive web interface to the user, the method further comprises:
providing a link on the interactive web interface to download a phone application required to evaluate the embedded project. For example, providing a QR (Quick Response) code, on the interactive web interface that a phone can scan to download a mobile application. The phone application can be necessary for an embedded project running on an embedded board. The phone application can configure the embedded project running on the embedded board or obtain data from the embedded board.

Based on the disclosure herein, a person skilled in the art can think of using a web application to perform other operations, such as a web serial console that can be run directly in a web browser for getting console access to the embedded project running on the embedded board. The user can view the web serial console log through the web serial console.

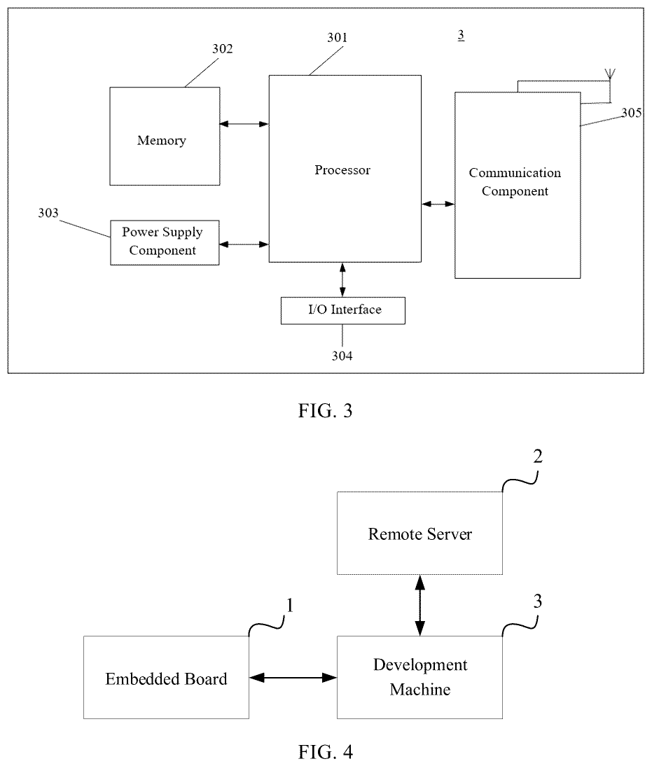

In addition, a development machine is also provided in the present disclosure. As shown in FIG. 3, which shows the structural block diagram of the development machine provided in this disclosure, the development machine 3 comprises a processor 301, a memory 302, a power supply component 303, and an input/output (I/O) Interface 304, and a communication component 305.

The processor 301 generally controls the overall operations of the development machine 3, such as operations associated with display, telephone calls, data communications, camera operations, and recording operations. The processor 301 may call the instructions stored in the memory 302 to complete all or part of the steps of the above-mentioned method.

The memory 302 is configured to store various types of data to support the operations of the development machine 3. Examples of these data include instructions, contact data, phone book data, messages, pictures, videos and the like for any application or method operating on the development machine 3. The memory 302 may be implemented by any type of volatile or non-volatile storage device or their combination, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 303 provides power for various components of the development machine 3. The power supply component 303 may include a power management system, one or more power supplies, and other components associated with the generation, managing, and distributing power for the development machine 3.

An input/output (I/O) interface 304 provides an interface between the processor 301 and peripheral interface modules. The above-mentioned peripheral interface modules may be a keyboard, a click wheel, a button, and the like. These buttons may include but are not limited to: home button, volume button, start button, and lock button.

The communication component 305 is configured to facilitate wired or wireless communication between the development machine 3 and other devices. The development machine 3 may access a wireless network based on a communication standard, such as Wi-Fi, 2G or 3G, or a combination thereof.

In an exemplary embodiment, the development machine 3 may be implemented by one or more application specific integrated circuits (ASIC), digital signal processors (DSP), digital signal processing devices (DSPD), programmable logic devices (PLD), field programmable gate array (FPGA), controller, microcontroller, microprocessor, or other electronic components to perform the above methods.

It can be understood that the development machine provided in this disclosure corresponds to the above-mentioned method for evaluating an embedded project, and the specific implementation may be referred to the above-mentioned content, which will not be repeated here.

In addition, this disclosure also provides a system for evaluating an embedded project, as shown in FIG. 4 showing the structural block diagram of the system for evaluating an embedded project provided by this disclosure, the system comprises: an embedded board 1, a remote server 2 and a development machine 3.

Here, the embedded board 1 is used to be written the image file. The remote server 2 is used to provide the image file and the manifest file. The development machine 3 is used to implement any one of the above-mentioned methods for evaluating an embedded project.

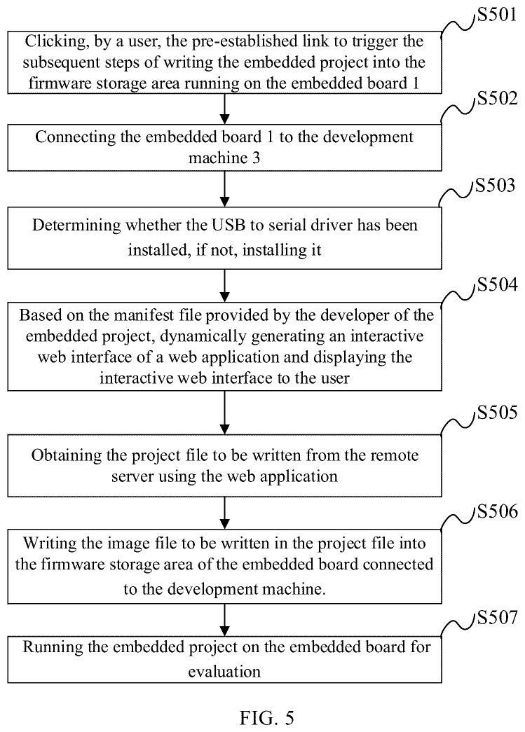

Referring to FIG. 5, the evaluation process performed by the system may comprise the following steps:
S501: clicking, by a user, the pre-established link to trigger the subsequent steps of writing the embedded project into the firmware storage area running on the embedded board 1.
S502: connecting the embedded board 1 to the development machine 3.
S503: determining whether the USB to serial driver has been installed, if not, installing it.
S504: based on the manifest file provided by the developer of the embedded project, dynamically generating an interactive web interface of a web application and displaying the interactive web interface to the user.
S505: obtaining the project file to be written from the remote server using the web application.
S506: writing the image file to be written in the project file into the firmware storage area of the embedded board connected to the development machine.
S507: running the embedded project on the embedded board for evaluation.

It is understandable that the above S502 and S503 may be executed before S501.

In this disclosure, a virtual host on the development board is not required, and any special software is not needed running on the device. It could use the network to realize the evaluation of the embedded project, without a series of complicated operations such as copying, installation, and compilation on the development machine. This disclosure can quickly program the embedded board in a simple way, and realize the project evaluation in a few steps. It can avoid time-consuming problems and reduce the chance of human errors or setup errors.

It is understandable that the system for evaluating an embedded project provided in this disclosure corresponds to the above-mentioned method for evaluating an embedded project, and the specific implementation may refer to the above content, which will not be repeated here.

Although various embodiments of various aspects of the present disclosure have been described for the purpose of the present disclosure, it should not be understood that the teachings of the present disclosure are limited to these embodiments. The features disclosed in a specific embodiment are not limited to this embodiment, but may be combined with features disclosed in different embodiments. For example, one or more features and/or operations of the method according to the present disclosure described in one embodiment may also be applied in another embodiment individually, in combination or as a whole. Those skilled in the art should understand that there are more possible alternative implementations and modifications, and various changes and modifications may be made to the above-mentioned system without departing from the scope defined by the claims of the present disclosure.

1. A method implemented by a development machine for evaluating an embedded project to be run on an embedded board, the method comprising the steps of:
receiving a trigger command from a user, the trigger command being used to obtain a manifest file provided by a developer of the embedded project;
based on the manifest file, dynamically generating an interactive web interface of a web application and displaying the interactive web interface to the user;
obtaining at least a project file to be written by using the web application, wherein the project file to be written is stored on a remote server and comprises at least a pre-built image file of the embedded project; and
writing the image file into a firmware storage area of the embedded board connected to the development machine, so as to run the embedded project on the embedded board for evaluation.

2. The method according to claim 1, wherein the step of, based on the manifest file, dynamically generating an interactive web interface of a web application and displaying the interactive web interface to the user comprises:
obtaining a pre-built manifest file from the remote server;
rendering a webpage based on the manifest file to obtain the interactive web interface, and displaying the interactive web interface to the user.

3. The method according to claim 2, wherein the step of obtaining at least a project file to be written by using a web application comprises:
obtaining, from the manifest file, a path where the project file to be written is stored on the remote server; and
obtaining the project file to be written based on the path by means of the web application.

4. The method according to claim 1, wherein the method further comprises:
displaying a pre-established link on the interactive web interface based on the data in the manifest file.

5. The method according to claim 1, wherein the manifest file further comprises constraints information, which is used to specify which type of chip and/or embedded board the embedded project supports.

6. The method according to claim 5, wherein after the step of displaying the interactive web interface to the user, the method further comprises:
receiving the type of chip and/or embedded board to be used as an input by the user through the interactive web interface; and
determining whether the type of chip and/or embedded board to be used is a type supported by the embedded project, and if so, executing an operation of writing the image file into the firmware storage area of the embedded board.

7. The method according to claim 1, wherein the manifest file further comprises an offset, and based on the offset, the image file is written to a designated location of the firmware storage area.

8. The method according to claim 1, wherein after the step of displaying the interactive web interface to the user, the method further comprises:
receiving input information by the user through the interactive web interface, and transmitting the input information to the embedded project running on the embedded board.

9. The method according to claim 1, wherein after the step of displaying the interactive web interface to the user, the method further comprises:
providing a link in the interactive web interface to download a phone application required to evaluate the embedded project.

10. The method according to claim 1, wherein the project file to be written is an embedded project file stored in an open-source repository or any file storage accessible over web.

11. The method according to claim 1, wherein the trigger command is clicking on a pre-established link.

12. The method according to claim 1, wherein the web application is a JavaScript application, which communicates with the embedded board through a web-serial interface.

13. A development machine, comprising a memory and a processor, wherein the memory is configured to store instructions, and wherein the instructions, when executed by the processor, implement actions of:
receiving a trigger command from a user, the trigger command being used to obtain a manifest file provided by a developer of the embedded project;
based on the manifest file, dynamically generating an interactive web interface of a web application and displaying the interactive web interface to the user;
obtaining at least a project file to be written by using the web application, wherein the project file to be written is stored on a remote server and comprises at least a pre-built image file of the embedded project; and
writing the image file into a firmware storage area of the embedded board connected to the development machine, so as to run the embedded project on the embedded board for evaluation.

14. A system for evaluating an embedded project, wherein the system comprising: an embedded board, a remote server, and the development machine according to claim 13.
